(19) United States
(12) Patent Application Publication
(10) Pub. No.: US 2012/0290509 A1
(43) Pub. Date: Nov. 15, 2012

(54) Training Statistical Dialog Managers in Spoken Dialog Systems With Web Data

(75) Inventors: Larry Paul Heck, Los Altos, CA (US); Dilek Hakkani-Tur, Fremont, CA (US); Rukmini Iyer, Los Altos, CA (US); Gokhan Tur, Fremont, CA (US)

(73) Assignee: Microsoft Corporation, Redmond, WA (US)

(21) Appl. No.: 13/234,186

(22) Filed: Sep. 16, 2011

Related U.S. Application Data
(60) Provisional application No. 61/485,778, filed on May 13, 2011.

(51) Int. Cl. G10L 11/00; G06F 15/18

(52) U.S. Cl. 706/11

(57) ABSTRACT

Training for a statistical dialog manager may be provided. A plurality of log data associated with an intent may be received, and at least one step associated with completing the intent according to the plurality of log data may be identified. An understanding model associated with the intent may be created, including a plurality of queries mapped to the intent. In response to receiving a natural language query from a user that is associated with the intent a response to the user may be provided according to the understanding model.

### RELATED APPLICATIONS

Under provisions of 35 U.S.C. §119(e), the Applicants claim the benefit of U.S. Provisional Application No. 61/485,778, filed May 13, 2011, which is incorporated herein by reference.

Related U.S. patent application Ser. No. ______, filed on even date herewith entitled “Exploiting Query Click Logs for Domain Detection in Spoken Language Understanding,” assigned to the assignee of the present application, is hereby incorporated by reference.

### BACKGROUND

Web data may be mined to provide training for spoken language understanding (SLU) applications. A significant barrier that limits the wide-scale deployment of statistical dialog managers (SDMs) is the amount of annotated dialogs that are required for training SDM models. The need for large training corpora arise from the large number of combinations of state variables in conjunction with the belief space over all possible outputs of a spoken language understanding system. In conventional systems, scaling SDM approaches to handle thousands of simulated dialogs is a key research problem, particularly in known partially observable Markov decision process (POMDP) approaches. For example, a conventional approach to solve this problem relies on a flat initialization; as the system is used, training data is obtained from real users and annotated to train better models. But such a bootstrapped statistical model is not desirable for real-world SDMs as the initial user experience is poor and limited. In addition, the subsequent learning is biased towards simplified interactions, since these are the only dialogs that that yield success for the user.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Training for a statistical dialog manager may be provided. A plurality of log data associated with an intent may be received, and at least one step associated with completing the intent according to the plurality of log data may be identified. An understanding model associated with the intent may be created, including a plurality of queries mapped to the intent. In response to receiving a natural language query from a user that is associated with the intent a response to the user may be provided according to the understanding model.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing statistical dialog manager training;

FIG. 3 is a flow chart of a method for interacting with a statistical dialog manager; and

FIG. 4 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Embodiments of the present invention may provide for a system and/or method for using web data to train statistical dialog managers (SDMs) in spoken dialog systems (SDS). Large volumes of logged user interactions that exist in centrally hosted web search engines and browsers may be leveraged to provide training data for a dialog manager. Users complete tasks everyday on the web, using a combination of search and browsing. The volume of the search data may exceed 100M queries per day over hundreds of millions of users, and the breadth of tasks is immense, resulting in “long tail” web searches. These tasks may range from simple ones (weather, finding directions, local events) to more complex (shopping, planning a trip, planning a night out). In the process of completing these tasks, users may engage in a limited dialog with their search engine and browser. For example, users may formulate a query that represents a particular goal or intent they have in mind, enter it into the search engine, and then respond with a reformulated query based on the results from the search engine. For another example, a sequence of navigation selections may be used to infer a user's intent without receiving an explicit query, such as where a user begins on a shopping site and browses through progressively narrower criteria (e.g., electronics→cameras→digital→SLR.)

Consistent with embodiments of the invention, spoken dialogs may be mapped from text/click searches and browser interactions. The goals/tasks and sequence of steps taken to complete the goals/tasks may be similar whether completed with a web browser or via a spoken dialog system, although the manifestation of the user's desired actions is different. To address this mismatch, the dialog modeling problem may be separated into two parts: (1) learning the underlying process of the goal/task completion from the web logs that is common between browser and SDS-based interactions, and (2) learning the translation of the user's web interactions (search queries, clicks) into natural spoken conversations.

The primary elements of task completion may be categorized as understanding how a user navigates a task, determining whether the user is satisfied with the system interaction, and predicting a system response based on progression through the task. These aspects may be learned from large-scale search/browser interactions and translated into an SDS. For instance, most current dialog systems model simpler tasks and do not plan for task interruptions or toggling across tasks. However, in more complex tasks such as planning a night out, we observe the user jumping between sub-tasks of “finding a movie to see” after having a “nice dinner outside”. Similarly, the order and/or sequencing of actions within a task may be learned based on web data such as where checking for hotels usually follows booking a flight.

Features for task completion learned from web interactions may also port over as features to a statistical dialog modeling system. For instance, time spent by the user on a search result post-click or click duration may be considered a good signal that the user has found an interesting result. In a spoken dialog or multi-modal system interaction, a user's spending time studying a map of restaurants delivered by the system may be considered a good signal that the system has delivered interesting results to the user. In web search, re-typing or re-formulating a query typically indicates that the user did not find satisfactory answers for the first query. With a dialog system, re-stating a question or simplifying a request to the system can similarly be considered indicators that the user interaction with the system is not smooth.

For spoken dialog systems, user satisfaction for statistical dialog management (SDM) may be scored by interpolating automatically computable factors. In learning the machine actions of the dialog manager, the user satisfaction score may be used as a reward for reinforcement learning. User satisfaction may also be scored by leveraging data from a user's web search and browsing activities. A Markov model classification approach may be applied to SDM and extended by computing the following four types of features to determine session success: features related to turns, features related to an overall session, features related to the queries, and features related to Uniform Resource Locators (URLs) clicked by a user.

A turn may comprise a user action, such as clicking on a search result or a paid ad, clicking on the Back button, entering a new query, and so on. Turn features may be related to the state sequence the user has followed with associated time information. For example, a Markov model of states taken may comprise a feature based on a first-order Markov model using 43 possible user actions (states). Two MMs may be trained using satisfied (MM_{S}) and dissatisfied (MM_{D}) sessions using a maximum likelihood estimation as described by Equation 1, below. Nₛ_{_{i,}}ₛ_{ⱼ} comprises a number of transitions from state sᵢ to sⱼ and Nₛ_{ᵢ} may comprise a number of times the state is visited.

$$P ( {s}_{i} , {s}_{j} ) = \frac{{N}_{{s}_{i} , {s}_{j}}}{{N}_{{s}_{i}}} \qquad Equation 1$$

A log-likelihood ratio score for determining successful sessions may be computed according to Equations 2 and 3, below, where Equation 3 describes the accumulated log-likelihoods of the transition probabilities from Markov model x.

$$\begin{matrix}{LL}_{MM} = log \frac{P ( {MM}_{s} )}{P ( {MM}_{D} )} & Equation 2 \\ log P ( {MM}_{x} ) = {\sum }_{i} log {T}_{x} ( {s}_{i - 1} , {s}_{i} ) & Equation 3\end{matrix}$$

A duration model (DrM) may comprise a dwell time modeled for each user action (state) pair (e.g., Query-Click). A Gamma distribution may be used to model the dwell times. Given a new session, a likelihood ratio of the probabilities using the Gamma function is computed for each state pair as described by Equation 4, below.

$${S}_{D τ M} = \frac{{Γ}_{S} ( {t}_{i} )}{{Γ}_{D} ( {t}_{i} )} \qquad Equation 4$$

Overall session features may comprise, for example, session length and/or duration, an average dwell time (i.e., total dwell time divided by the number of states), a number of queries, an average query length, a minimum and/or maximum dwell time between states, and/or a total number of repeated queries. Other session features may comprise a number of algorithmic clicks (i.e., number of clicks to one result), a number of ad clicks, and a total number of occurrences of a “Query” state and/or an “Other” state.

Query features may comprise historical features that may represent behavior from other users who entered the same query as the current user. To obtain these features, previous occurrences of the queries in the current session may be mined from a search log database. From these past queries, the associated actions of the users may be extracted and the mean, minimum, and/or maximum of the various derived features may be computed. Such derived features may comprise, for example, query frequency, number/percentage of URL clicks, and/or query click entropy.

Query frequency may comprise the number/percentage of times a query was entered by other users. Frequent queries are usually easily handled by search engines, hence sessions that include frequent queries may have a higher chance of success. The number of URL clicks may comprise the number and/or percentage of times a user clicks on a link returned by the search engine after the query was entered. The type of the clicked links, such as an advertisement link, or a new query suggestion, may also be considered, and the number/percentage of specific types of link clicks may also be computed.

Query click entropy, E(q) may comprise a measure of the diversity of the URLs clicked by the users of a query q, as represented by Equation 5.

$$E ( q ) = {\sum }_{i = 1}^{n} P ( {U}_{i} ) ln P ( {U}_{i} ) \qquad Equation 5$$

Uᵢ, i=1, . . . , n may comprise URLs clicked by users of query q and P(Uᵢ) comprises the normalized frequency of a URL Uᵢ as computed according to Equation 6, where F(Uᵢ) comprises the number of times the URL Uᵢ is clicked.

$$P ( {U}_{i} ) = \frac{F ( {U}_{i} )}{{\sum }_{i = 1}^{n} F ( {U}_{i} )} \qquad Equation 6$$

Features related to the urls clicked by the user may be similar to the previous set of features, as they may be computed using the query logs and clicks of the previous users who typed the same query, q. Given the set of URLs that the current user clicked in time order, A=a₁, . . . aₙ, and the set of URLs clicked by other users who typed the same query clicked in frequency order, U=u₁, . . . , uₘ binary features may be computed that check if a₁=u₁, u₁ ∈ A and a₁ ∈ U. P(a₁|Q) and P(a₁,Q), and avgᵢP(aᵢ|Q) and avgᵢP(aᵢ,Q) may also be computed. Separating satisfied sessions from dissatisfied ones may be framed as a binary classification problem. To this end, these features, F, may be used to train a logistic regression classifier to get a confidence score according to Equation 7, where the β values for each feature fᵢ ∈ F are learned from the training data.

$$p ( c = SAT \vert F ) = \frac{1}{1 + exp ( - {\sum }_{i} ( {β}_{i} \times {f}_{i} ) )} \qquad Equation 7$$

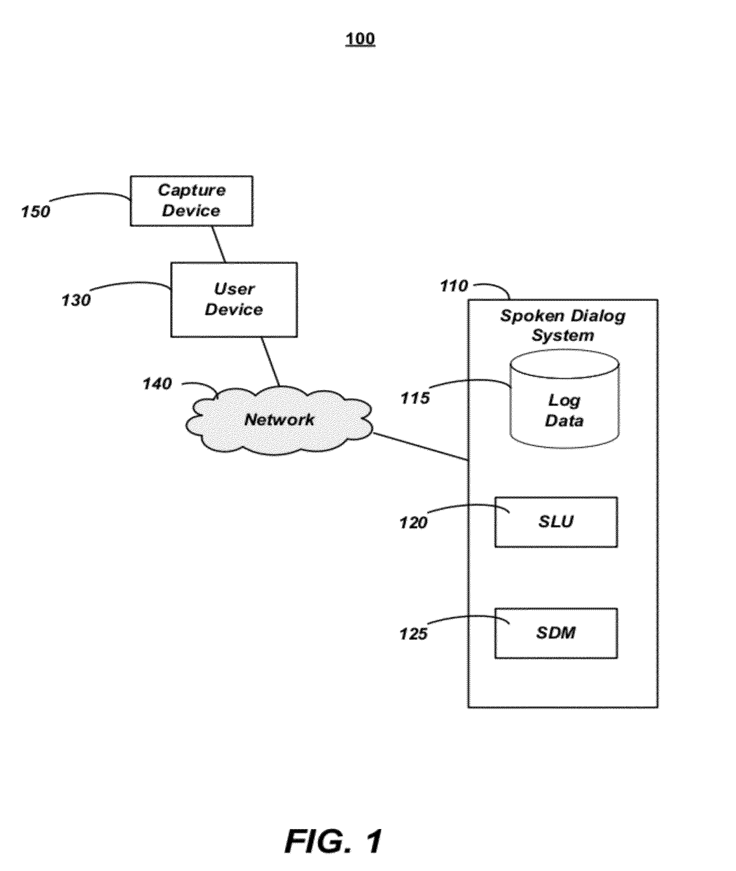

FIG. 1 is a block diagram of an operating environment 100 for providing a spoken dialog system (SDS) 110. SDS 110 may comprise a log data storage 115, a spoken language understanding component 120, and a statistical dialog manager 125. SDS 110 may be operative to interact with a user device 130 over a network 140. User device 130 may comprise an electronic communications device such as a computer, laptop, cell phone, tablet, game console and/or other device. User device 130 may be coupled to a capture device 150 that may be operative to record a user and capture spoken words, motions and/or gestures made by the user, such as with a camera and/or microphone. User device 130 may be further operative to capture other inputs from the user such as by a keyboard, touchscreen and/or mouse (not pictured). Consistent with embodiments of the invention, capture device 150 may comprise any speech and/or motion detection device capable of detecting the actions of the user. For example, capture device 150 may comprise a Microsoft® Kinect® motion capture device comprising a plurality of cameras and a plurality of microphones.

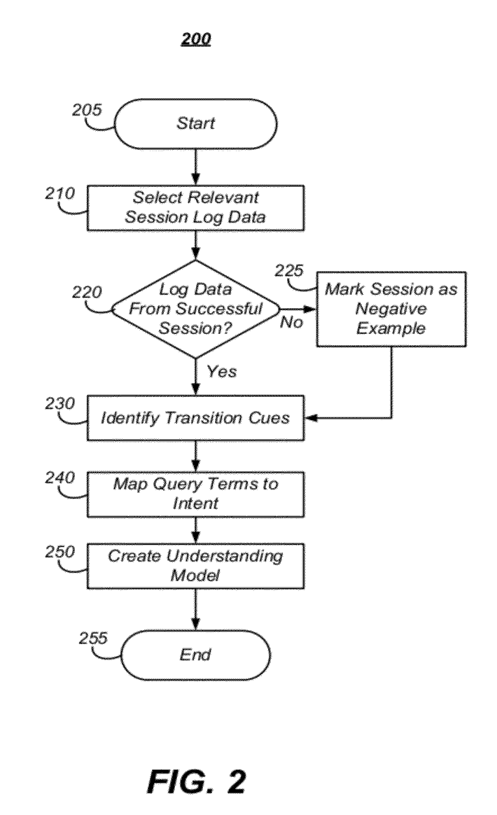

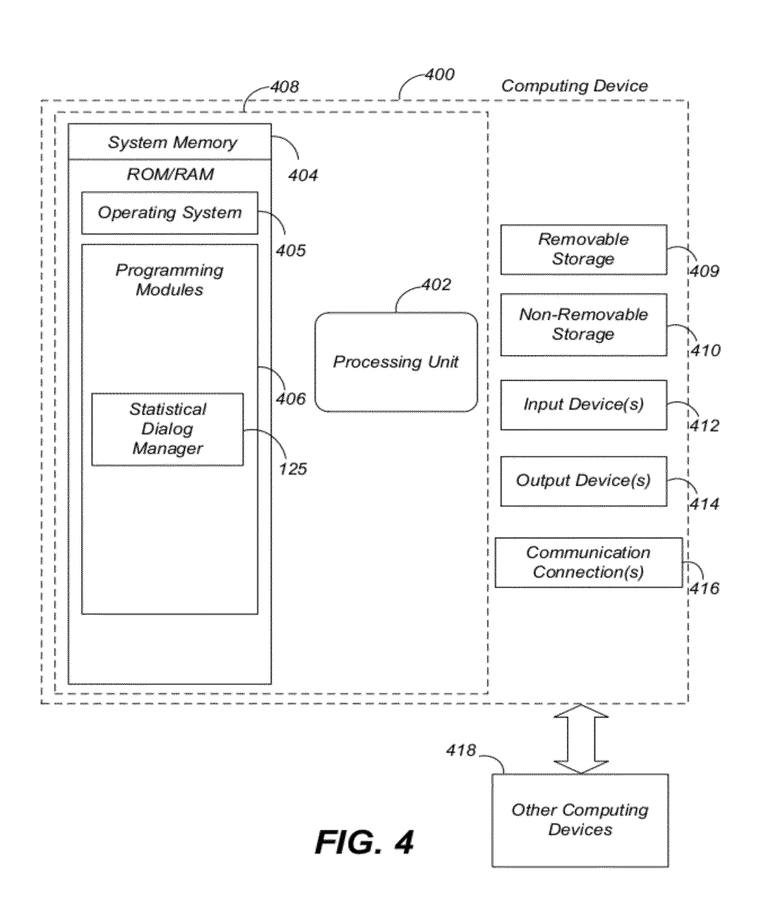

FIG. 2 is a flow chart setting forth the general stages involved in a method 200 consistent with an embodiment of the invention for providing statistical dialog manager training. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may select a plurality of session log data. For example, SDS 110 may mine through a plurality of web session log data to select those sessions that attempt to accomplish a particular intent, such as booking reservations at a restaurant. Log data may be selected based on key query terms, such as “restaurant”, “reviews”, “availability”, etc. and/or inclusion in the web data of known restaurant reservation websites, such as opentable.com.

Method 200 may then advance to stage 220 where computing device 400 may determine whether the log data from each session is associated with a successful completion of the intent. For example, SDS 110 may determine whether a given web session for a restaurant reservation intent resulted in a successful reservation being made. SDS 110 may also analyze failed sessions to attempt to identify steps that may present problems, such as broken links to specific restaurants' web sites, no reservations available, etc.

If the session is determined not to be successful, method 200 may advance to stage 225 where computing device 400 may mark the data for that session as a negative example. Such negative examples may provide useful training data for learning actions that result in unsuccessful dialogs. Method 200 may then continue to stage 230 for further processing.

Successful sessions may be added to the selected plurality of session log data as being associated with the desired intent, and method 200 may advance to stage 230 where computing device 400 may identify transition cues within the data. For example, SDS 110 may analyze the selected data to identify individual steps used in completing the intent. With a restaurant search, the user may first browse other invitees' calendars to identify a time all are available before going to an aggregator site to search for reservations available at that time. The list of available restaurants may be filtered by location, type of food, price, etc. Several of these steps may be performed in interchangeable order across the various web sessions, but others may usually come in a particular order that may be used as the basis for transition cues. For example, once a desired time is identified, the user may transition to searching for reservations available at that time. Conversely, once available reservation times are identified at a desired restaurant, the user may transition to determining whether all of the attendees are available at that time.

Transition cues may also be identified between domains within an intent and/or between overall intents. For example, an intent to book a travel trip may cross domains such as airplane tickets, rental cars, hotel reservations, and entertainment plans. Transition cues may be identified between those domains, such as completing payment of the ticket and/or receiving a confirmation number, that indicate that the user is ready to move on to the next step, domain, and/or intent.

Method 200 may then advance to stage 240 where computing device 400 may map a plurality of query terms to an intent. For example, web session data may be selected for a restaurant reservation intent at stage 210 by identifying log data associated with the opentable.com website. This data may be scanned for common key words and/or phrases that may be used to refine the overall search for a restaurant.

Method 200 may then advance to stage 250 where computing device 400 may create an understanding model. For example, SDS 110 may bundle the key terms, likely websites, likely steps, and transition cues into an understanding model for SDM 125. Method 200 may then end at stage 255.

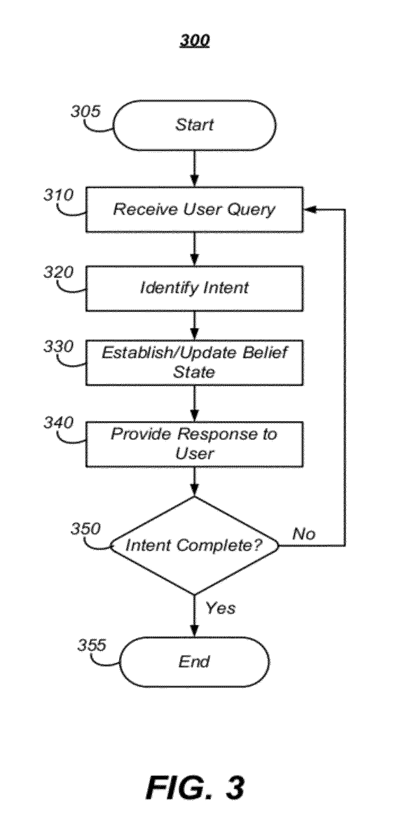

FIG. 3 is a flow chart setting forth the general stages involved in a method 300 consistent with an embodiment of the invention for interacting with a statistical dialog manager. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may receive a query from a user. For example, capture device 150 may record a spoken natural language phrase from a user such as “what's good to eat around here?”

Method 300 may then advance to stage 320 where computing device 400 may identify an intent associated with the user's query. For example, using the understanding model created in method 200, the keywords “eat” and “around here” may be identified as providing cues to user's intent to locate a restaurant.

Method 300 may then advance to stage 330 where computing device 400 may establish a belief state associated with the user's intent. For example, the belief state may comprise the end goal of the intent of locating a nearby restaurant, one or more domains associated with the intent (e.g., local area, restaurant by cuisine, reviews, reservations), and a plurality of slots that may be used to refine the user's query. Initial slots may be filled based on the query, such as setting a center point location and radius for the search based on the “around here” term. Other slots may be filled based on the understanding model. For example, a time slot may be populated with a default of “now” based on the analysis of prior web search sessions that indicates that users who do not specify a time in their initial query are generally searching for some place to eat in the near future.

Method 300 may then advance to stage 340 where computing device 400 may provide a response to the user. For example, SDS 110 may perform a web search and return a list of nearby restaurants for display on user device 130.

Method 300 may then advance to stage 350 where computing device 400 may determine whether the intent is complete. For example, the understanding model may indicate that users generally want to refine a search from an initial list. SDS 110 may prompt the user for more information, such as by asking what cuisine the user is looking for. Method 300 may then return to stage 310 to process the user's response as described above, such as by verifying that the response is associated with the same intent at stage 320 and updating the belief state at stage 330 according to the user's response. Otherwise, if the user deactivates user device 130 (e.g., by turning off or locking the display screen) or starts moving in the direction of one of the restaurants, or if the understanding model indicates that the previously provided response is usually the final step of completing the intent, the intent may be assumed to be complete and method 300 may end at stage 355.

An embodiment consistent with the invention may comprise a system for providing statistical dialog manager training. The system may comprise a memory storage and a processing unit coupled to the memory storage. The processing unit may be operative to receive a spoken query from a user, create a belief state according to the spoken query, wherein the belief state comprises an estimated intent of the user, determine whether at least one of a plurality of log data is associated with the estimated intent, and, if so, update the belief state according to at least one element of the at least one of the plurality of log data and provide a response to the user according to the updated belief state.

Another embodiment consistent with the invention may comprise a system for providing statistical dialog manager training. The system may comprise a memory storage and a processing unit coupled to the memory storage. The processing unit may be operative to receive a plurality of log data associated with an intent, identify at least one step associated with completing the intent according to the plurality of log data, and create an understanding model associated with the intent, map a plurality of queries to the intent. In response to receiving a natural language query from a user, the processing unit may be operative determine whether the natural language query is associated with the intent and, if so, provide a response to the user according to the understanding model.

Yet another embodiment consistent with the invention may comprise a system for providing statistical dialog manager training. The system may comprise a memory storage and a processing unit coupled to the memory storage. The processing unit may be operative to select a subset of a plurality of log data as being associated with an intent, determine whether at least one of the subset of log data is associated with a successful completion of the intent, and, if not, discard the at least one of the subset of log data. If the log data is associated with the successful completion of the intent, the processing unit may be further operative to identify a plurality of transition cues within the subset of log data, map a plurality of query terms to the intent according the subset of log data, and create an understanding model associated with completing the intent according to the subset of log data. The processing unit may be further operative to receive a natural language query from a user, establish a belief state associated with the natural language query, populate the belief state (e.g., according to the understanding model, a belief state from a previous user input, information previously presented to the user, etc.) and provide a response to the user according to the belief state.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise operating environment 400 as described above. Methods described in this specification may operate in other environments and are not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include SDM 125. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 404, including operating system 405. While executing on processing unit 402, programming modules 406 (e.g., statistical dialog manager 125) may perform processes and/or methods as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with SDS 110 may operate via application-specific logic integrated with other components of the computing device/system X on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing statistical dialog manager training, the method comprising:
receiving a spoken query from a user;
creating a belief state according to the spoken query, wherein the belief state comprises an estimated intent of the user;
determining whether at least one of a plurality of log data is associated with the estimated intent; and
in response to determining that the at least one of the plurality of log data is associated with the estimated intent:
updating the belief state according to at least one element of the at least one of the plurality of log data, and
providing a response to the user according to the updated belief state.

2. The method of claim 1, wherein the plurality of log data is associated with a plurality of web searches.

3. The method of claim 2, wherein the plurality of web searches are each associated with a common intent.

4. The method of claim 1, further comprising:
in response to determining that the at least one of the plurality of log data is not associated with the estimated intent:
querying the user for at least one additional cue,
receiving a response to the query from the user, and
updating the believe state according to the received response.

5. The method of claim 1, wherein the response provided to the user comprises a link to a web page.

6. The method of claim 1, wherein the response provided to the user comprises a suggested next action.

7. The method of claim 1, further comprising updating the belief state with the provided response.

8. The method of claim 7, further comprising:
receiving a second spoken query from the user;
determining whether the second spoken query is associated with the estimated intent; and
in response to determining that the second spoken query is associated with the estimated intent:
updating the belief state according to the second spoken query, and
providing a second response to the user according to the updated belief state.

9. The method of claim 8, further comprising:
determining whether the second spoken query is associated with a transition to a second intent; and
in response to determining that the second spoken query is associated with the transition:
creating a second belief state according to the second spoken query,
populating at least one element of the second belief state according to the previously created belief state, and
providing a third response to the user according to the second belief state.

10. The method of claim 9, wherein the belief state comprises at least one intent element, at least one domain element, and a plurality of slot elements.

11. The method of claim 10, wherein the plurality of slot elements each comprise qualifying data associated with achieving the estimated intent.

12. A system for providing statistical dialog manager training, the system comprising:
a memory storage; and
a processing unit coupled to the memory storage, wherein the processing unit is operable to:
receive a plurality of log data associated with an intent,
identify at least one step associated with completing the intent according to the plurality of log data,
create an understanding model associated with the intent,
map a plurality of queries to the intent,
in response to receiving a natural language query from a user, determine whether the natural language query is associated with the intent, and
in response to determining that the natural language query is associated with the intent, provide a response to the user according to the understanding model.

13. The system of claim 12, wherein the processing unit is further operative to:
identify at least one transition cue according to the plurality of log data; and
incorporate the at least one transition cue into the understanding model.

14. The system of claim 13, wherein the transition cue is associated with at least one of the following: a new task associated with completing the intent and a second intent.

15. The system of claim 12, wherein the plurality of log data comprises a subset of a plurality of search log data associated with a plurality of users performing a plurality of searches associated with a plurality of intents.

16. The system of claim 15, wherein the plurality of log data is selected as being associated with the intent by identifying at least one web page known to be associated with the intent within the plurality of search log data.

17. The system of claim 15, wherein the plurality of log data is selected as being associated with the intent by identifying at least one search term known to be associated with the intent within the plurality of search log data.

18. The system of claim 12, wherein the processing unit is further operative to determine, for each of the plurality of log data, whether the intent was successfully accomplished.

19. The system of claim 12, wherein the processing unit is further operative to refine a belief state associated with the intent in response to receiving at least one additional natural language query from the user.

20. A computer-readable medium which stores a set of instructions which when executed performs a method for providing training for a statistical dialog manager, the method executed by the set of instructions comprising:
selecting a subset of a plurality of log data as being associated with an intent, wherein each of the subset of the plurality of log data comprises a session log associated with at least one of the following: a keyword and a website;
determining whether at least one of the subset of log data is associated with a successful completion of the intent;
in response to determining that the at least one of the subset of log data is not associated with the successful completion of the intent, discarding the at least one of the subset of log data;
identifying a plurality of transition cues within the subset of log data, wherein each of the transition cues is associated with at least one of the following: a new task associated with completing the intent and a second intent;
mapping a plurality of query terms to the intent according the subset of log data;
creating an understanding model associated with completing the intent according to the subset of log data;
receiving a natural language query from a user;
determining, according to the mapped plurality of query terms, whether the natural language query is associated with the intent; and
in response to determining that the natural language query is associated with the intent:
establishing a belief state associated with the natural language query,
populating the belief state according to the understanding model, and
providing a response to the user according to the belief state.
